(19) United States
(12) Patent Application Publication
(10) Pub. No.: US 2025/0217069 A1
(43) Pub. Date: Jul. 3, 2025

(54) STREAMING MATRIX TRANSPOSER WITH DIAGONAL STORAGE

(71) Applicant: Akeana, Inc., Santa Clara, CA (US)

(72) Inventor: David Cureton Baker, Austin, TX (US)

(73) Assignee: Akeana, Inc., Santa Clara, CA (US)

(21) Appl. No.: 19/001,251

(22) Filed: Dec. 24, 2024

Related U.S. Application Data
(60) Provisional application No. 63/679,192, filed on Aug. 5, 2024.
(60) Provisional application No. 63/735,937, filed on Dec. 19, 2024.
(60) Provisional application No. 63/630,106, filed on Jan. 3, 2024.

(51) Int. Cl. G06F 3/06

(52) U.S. Cl. CPC G06F 3/0655; G06F 3/0604; G06F 3/0679

(57) ABSTRACT

A memory array is accessed. The memory array includes a plurality of memory banks. Each column in the memory array is associated with a unique memory bank within the plurality of memory banks. A request is received to transpose a matrix which comprises i rows and j columns. The matrix is saved in the memory array, which includes rotating, to the right, each row within the i rows. The rotating is based on a row index. The saving results in a diagonal format of the matrix within the memory array. The diagonal format of the matrix is read from the memory array, which includes rotating, to the left, each row with the diagonal format of the matrix. The reading produces a transpose of the matrix.

### RELATED APPLICATIONS

This application claims the benefit of U.S. provisional patent applications “Tensor Transpose Accelerator Memory System” Ser. No. 63/630,106, filed Jan. 3, 2024, “Weight-Stationary Matrix Multiply Accelerator With Tightly Coupled L2 Cache” Ser. No. 63/679,192, filed Aug. 5, 2024, and “Systolic Array Matrix-Multiply Accelerator With Row Tail Accumulation” Ser. No. 63/735,937, filed Dec. 19, 2024.

### FIELD OF ART

This application relates generally to data processing and more particularly to a streaming matrix transposer with diagonal storage.

### BACKGROUND

Humans accumulate things. These accumulated items include food, clothing, money, cars, houses, baseball cards, books, horses, stamps, newspapers, clocks, relationships, and on and on and on. We measure success based in part on the number and value of the things we have accumulated. We assign failure to the lack of accumulated things. Those without a place to live, without a vehicle, without more than one set of clothes, or without a bank account are considered to be “poor,” and our society works to help them acquire basic forms of these items in order to “succeed.” Having acquired things, whether they are consumable items or more permanent in nature, we look for ways to save and protect them. Food items need to be kept cool and away from contaminants, clothing needs to be kept clean and dry, household items must be kept in proper environments, people need to be protected from the elements. Storing our stuff is an ongoing challenge throughout our society, whether we have a little or a lot. This is not only true in today's society; it has been a challenge for cultures across time and geography.

Early humans determined that keeping game and edible plants cool and dry made them last longer. Keeping animals away from saved food was also important. Meat could be dried or smoked to keep it from rotting. Salt was used to preserve food as well. Once prepared, food could be wrapped in leaves and buried in the ground, in ice or snow, or placed in caves to keep it cool. Rocks, branches, thorny bushes, and so on could be used to protect access to the stored food. As civilization progressed, fermentation processes began to be developed for foods such as sauerkraut, kimchi, and yogurt. Canning processes were developed to preserve foods in airtight containers that could be heated to kill bacteria. With the advent of refrigeration in the 19^{th} century, perishable foods could be stored at low temperatures for extended periods of time. Today, many homes and businesses routinely use both refrigerators and freezers to store foods acquired from grocers or made on location. Plentiful supplies of foods allow homes and businesses to reduce the amount of storage space required, depending on grocers, farmers, and warehouses to supply what is needed in a timely manner.

Specialized storage spaces have been developed for all manner of goods. Homes are essentially customized storage spaces, designed to hold and provide ready access to an individual or family's accumulated stuff. Kitchens hold our food and implements to prepare it; bathrooms store toiletries, medicines, and beauty aids; bedrooms hold mattresses, blankets, pillows, clothing, and jewelry; other rooms are used for placing furniture, rugs, paintings, and other collectibles; garages store our vehicles, and so on. Many homes have basements, attics, and even additional buildings designed to hold more things and keep them safe and useable.

Businesses build or purchase access to warehouses and other specialized storage facilities for raw or manufactured goods to be used in processes large and small. Automobile parts come from many fabricators and manufacturers to be stored in automated facilities and shipped to assembly areas just in time to be used in putting vehicles together. The amount of storage space to be used is kept as low as possible to allow for the various parts to be used as efficiently as possible with as little waste as possible. Storage space requires resources for maintenance, inventory control, shipping, and security. Making these resources run as smoothly as possible keeps costs low and productivity high. Throughout our society, storage and management of our accumulated goods will continue to be a challenge for individuals, families, and organizations. Plenty and scarcity drive our economic engine, and storage is a necessary part of moving our society forward.

### SUMMARY

The need for new applications and increased performance has driven significant artificial intelligence (AI) adoption across many industries. Self-driving cars, chatbots, improvements to healthcare, robotics, and so on have all been enabled or enhanced to a significant degree by advanced machine learning models. To meet these and future processing demands, engineers have been pushed to design faster hardware including processors, AI accelerators, systems on chips (SoCs), and so on. Entire ecosystems have been created to optimize AI performance of machine learning models such as neural networks, large language models, transformers, and so on. These ecosystems can include high bandwidth memory, system boards, server racks, and liquid-cooled datacenters. Machine learning models such as those listed above require high performance linear algebraic functions including matrix multiply, matrix addition, matrix transpose, and so on. These functions are often massively parallelized since they operate on matrices with row and column counts into the thousands or more. Traditional general-purpose processors are generally not optimized for the parallel processing demands and specialized calculations that AI workloads require. To support these needs, and to fully take advantage of today's AI ecosystems, specialized hardware can be added to processors and/or dedicated hardware which can accelerate parallelized linear algebraic functions.

Disclosed embodiments provide techniques for accelerating key matrix operations to support AI performance. A memory array is accessed. The memory array includes a plurality of memory banks. Each column in the memory array is associated with a unique memory bank within the plurality of memory banks. A request is received to transpose a matrix which comprises i rows and j columns. The matrix is saved in the memory array, which includes rotating, to the right, each row within the i rows. The rotating is based on a row index. The saving results in a diagonal format of the matrix within the memory array. The diagonal format of the matrix is read from the memory array, which includes rotating, to the left, each row with the diagonal format of the matrix. The reading produces a transpose of the matrix.

A processor-implemented method for data processing is disclosed comprising: accessing a memory array, wherein the memory array includes a plurality of memory banks, and wherein each column in the memory array is associated with a unique memory bank within the plurality of memory banks; receiving a request to transpose a matrix, wherein the matrix comprises i rows and j columns; saving, in the memory array, the matrix, wherein the saving includes rotating, to the right, each row within the i rows, wherein the rotating is based on a row index, and wherein the saving results in a diagonal format of the matrix within the memory array; and reading, from the memory array, the diagonal format of the matrix, wherein the reading includes rotating, to the left, each row within the diagonal format of the matrix, and wherein the reading produces a transpose of the matrix.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for a streaming matrix transposer with diagonal storage.

FIG. 2 is a flow diagram for assembling submatrices.

FIG. 3 is an example of transposing a matrix.

FIG. 4 is an example of generating a column address.

FIG. 5 is an illustration of reading a transposed matrix from a memory array.

FIG. 6 is an example of dividing a large matrix transpose function.

FIG. 7 is a block diagram of a streaming matrix transposer.

FIG. 8 is a block diagram of an AI accelerator.

FIG. 9 is a system diagram for a streaming matrix transposer with diagonal storage.

### DETAILED DESCRIPTION

Acceleration of artificial intelligence operations has become foundational to modern system designs. Some level of AI acceleration can be achieved through added functionality within a processor core, multiple cores, SoCs, and so on. For example, matrix multiply units can integrated as functional units in existing processors. These units can multiply matrices stored in register files and save results in another register, memory location, etc. While such “on-chip” acceleration can provide some acceleration, separate AI accelerator chips have proven to be far more effective, especially in managing large datasets. In this case, data can be written to a separate AI accelerator chip by a processor core through a pre-defined interface. The processor core can continue with other tasks as the AI accelerator, which is optimized for AI training and/or inferences, computes complex matrix multiply calculations. However, in the course of managing and multiplying large matrices, the need for other functions, such as matrix transposes, can arise. For example, to multiply a weight matrix with an activation matrix, either matrix may need to be reformatted to match the expected input structure of the network. A matrix transpose function can also be useful in managing the dimensions (and thus, the complexity) of a machine learning model such as a neural network. Although AI accelerators can excel at speeding up matrix multiply functions, other necessary functions, such as a matrix transpose, can cause performance bottlenecks. Further performance issues can arise due to the fact that a matrix transpose may be required of a tensor, which can include many larger matrices. For example, machine learning models may operate on multidimensional data, such as a 1000 by 1000 by 128 tensor. This means that functions, such as a matrix transpose, must be applied to 128 1000×1000 matrices. The execution of such a function can cause a significant slowdown in traditional hardware designs.

Disclosed embodiments provide techniques for accelerating matrix transpose functions. A memory array is accessed. The memory array includes a plurality of memory banks. Each column in the memory array is associated with a unique memory bank within the plurality of memory banks. A request is received to transpose a matrix, which comprises i rows and j columns. The matrix is saved in the memory array, which includes rotating, to the right, each row within the i rows. The rotating is based on a row index. The rotating can align each element within each row of the matrix with a unique memory bank in the plurality of memory banks. This can enable saving all elements of the matrix in a single cycle of the memory array. The saving results in a diagonal format of the matrix within the memory array. The memory array can store two or more matrices. The receiving can include a second matrix. The saving and the reading can include a base address. The base address can index between the matrix and the second matrix stored within the memory array. The diagonal format of the matrix is read from the memory array. The reading includes rotating, to the left, each row with the diagonal format of the matrix. The reading can be accomplished within a single cycle of the memory array. The reading produces a transpose of the matrix. A second memory array can be accessed. The request can include alternating between the memory array and the second memory array, thus comprising a streaming matrix transposer.

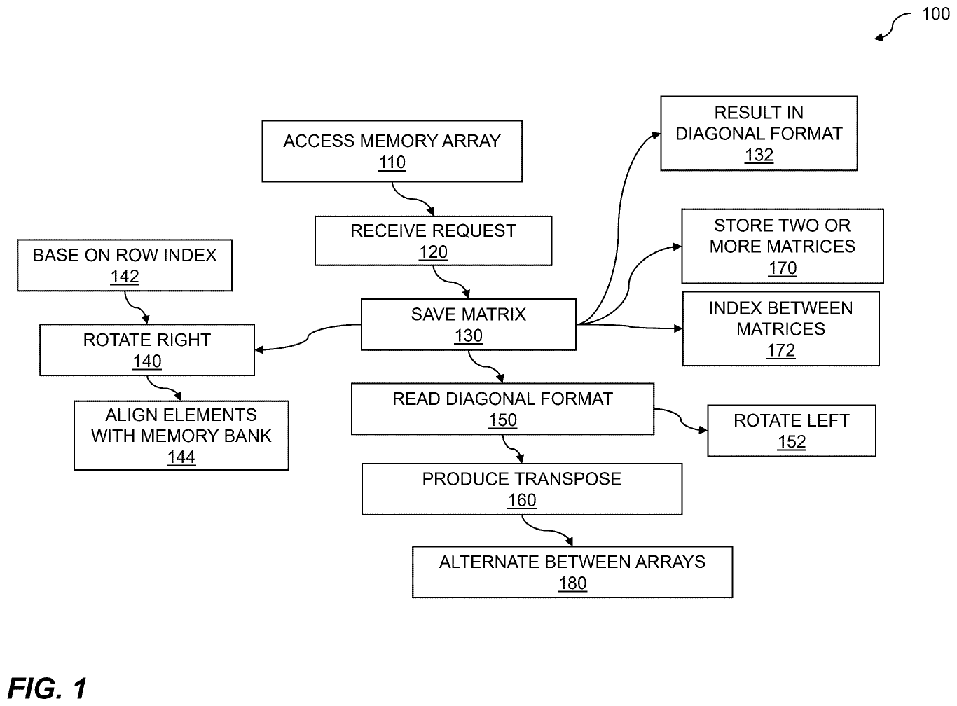

FIG. 1 is a flow diagram for a streaming matrix transposer with diagonal storage. The flow 100 includes accessing a memory array 110. The memory array can include any number of rows and columns and can be included in a processor core, a multi-core processor chip, an application specific integrated circuit (ASIC), an AI accelerator, a system-on-chip (SoC) and so on. The memory array can be coupled to other elements such as a memory hierarchy which can include an L1, L2, and L3 cache; I/O components, and so on. The memory array includes a plurality of memory banks. The memory banks can comprise any type of memory. The memory banks can comprise elements such as buffers, DRAM, SDRAM, DDR SDRAM, HBM memory, and so on. Each column in the memory array is associated with a unique memory bank within the plurality of memory banks. The memory banks can include a single read and write port. Thus, an access to a memory port can access a full column of data, within the memory array, with a single read port and write port. Other configurations of the memory banks with multiple read ports and/or write ports are possible.

The flow 100 includes receiving a request to transpose a matrix 120. Multiplying two matrices is only possible when the number of rows in a first matrix is the same as the number of columns in a second matrix. In some situations, such as processing matrices within a machine learning model, a transformation such as a matrix transpose is required to convert a matrix into a form by which it can be multiplied by another matrix. In a simple usage example, a need may arise to multiply a 4×3 matrix by another 4×3 matrix. Mathematically, this operation would be undefined since the number of rows in the first matrix (4) is not equal to the number of columns in the second matrix (3). However, transposing the second matrix results in a 3×4 matrix. Now, the number of rows of the first matrix (4) is equal to the number of columns of the second matrix (4) and the multiplication can be performed. The transformation of the data can be taken into account in subsequent calculations.

A transpose of a matrix can swap the rows and columns of a matrix. That is, a transpose function can convert a row-major matrix to a column-major matrix, and vice versa. A row-major matrix can indicate that values within the rows of the matrix are stored contiguously in memory while a column-major matrix can indicate that values within the columns of the matrix are stored contiguously in memory. The transpose request can result from multiplying matrices in a machine learning model such as a neural network, a convolutional neural network (CNN), a large language model (LLM), a transformer, and so on. For example, machine learning models may operate on multidimensional data, such as a 1000 by 1000 by 128 tensor. This means that functions, such as a matrix transpose, must be applied to 128 1000×1000 matrices. In some exemplarity implementations of extremely large models such as transformers, even larger numbers of more complex matrices may need to be transposed. The multiple matrix transpose requests can be included in a single request or multiple requests to the memory array.

The transpose request can be sent by a processing element such as a processor core, a multi-processor chip, an application specific integrated circuit (ASIC), a system-on-chip (SOC), an AI accelerator, a network of such processing elements, and so on. The memory array can be integrated on any processing element such as those listed above or a standalone chip. The request can be generated from the same chip as the memory array, or a different chip. Further, the request can be sent over a communications protocol such as the peripheral component interconnect express (PCIe). The request can include handshaking between the memory array and other elements. The request can include the matrix or matrices to be transposed. Alternatively, the matrix or matrices can be located in a register file, a memory address, a cache, and so on. In this case, the request can include an address to access the matrix or matrices. The matrix comprises i rows and j columns. The matrix or matrices associated with the request can be of any size and can comprise any number of rows and columns.

The flow 100 includes saving, in the memory array, the matrix 130. The matrix can be saved by a processor, multi-core processor, SoC, etc. The matrix can comprise any data type. For example, the matrix can comprise integer numbers, such as, INT8, INT16, INT32, etc., or floating-point numbers such as FP32, FP64, etc. The matrix can comprise brain floating point number formats such as BF8, BF16, and so on. Brain floating point formats can be a shortened version of a single precision floating point number which can reduce storage requirements and accelerate machine learning tasks. The matrix can comprise Microscaling Formats such as MXFP8, MXFP6, MXINT8 and so on. Microscaling Formats (MX) can be optimized for AI applications where energy efficiency and memory bandwidth reduction are priorities. MXFP6 is especially well suited for deep learning models that involve large datasets, such as image classification, language processing, and speech recognition. By using lower-bit formats, including MXFP6, these applications can perform faster inference with smaller memory footprints, making them suitable for hardware with limited memory and energy constraints, such as edge devices.

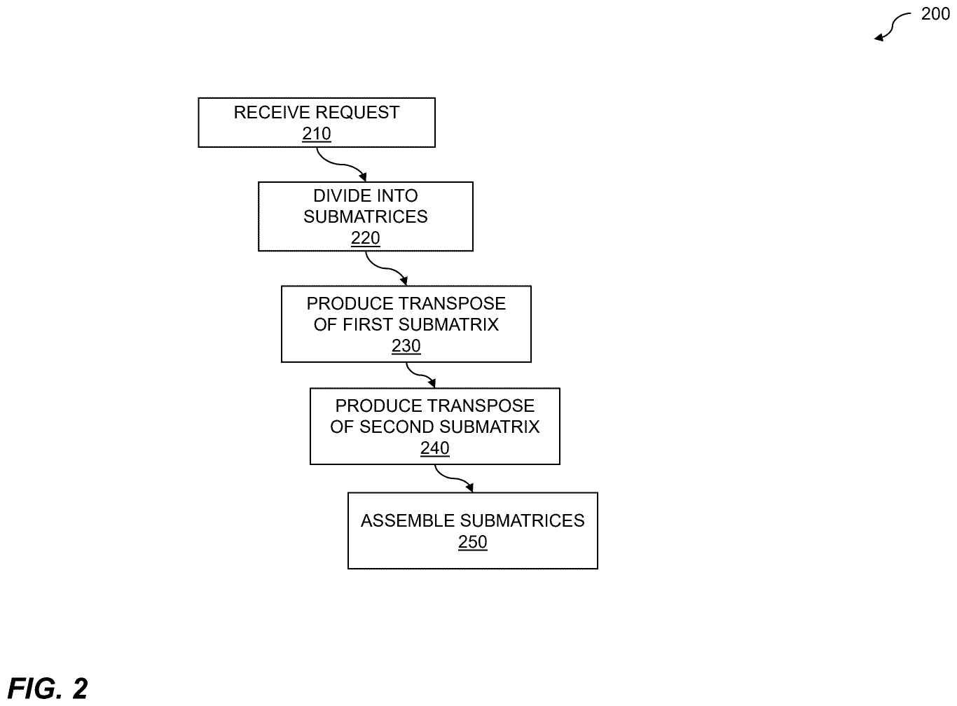

Each bank within the memory array can be designed to be at least as wide as the minimal data type to be supported. For example, if the minimal data type to be supported is FP8 (8-bit floating point values), then each memory bank can be designed to provide at least an 8-bit wide read path and at least an 8-bit wide write path. This can ensure that the matrix can be written to the memory array in a single cycle. Likewise, the data path size can be chosen to enable the matrix to be read from the memory array in a single cycle. As described above, the matrix can be part of a larger operation, such as a tensor operation, which can be generalized as an N-dimensional matrix. The matrix can comprise a division of a larger matrix. In a usage example, multiple smaller matrices can be transposed and then “stitched” back together to form a transpose of a larger matrix (described in FIG. 2).

The saving includes rotating, to the right 140, each row within the i rows. The rotating can shift values within a row of a matrix. In a usage example, the initial row of a simple 3×3 matrix can be rotated to the right by one element. In this example, the first element of the first row will shift to a second position within the row; the second element within the first row will shift to the third position; and the third element within the first row will rotate back to the first position. This operation can be performed on all rows of the matrix and each row can be rotated by a different rotation value. Each row within the matrix can be accessed by a row address. The row address can be a row index. The rotating is based on a row index 142. The row index can start with zero for the first row of the matrix. Thus, the first row can be rotated right by zero elements (no rotations), the second row can be rotated right by one element, the third row can be rotated right by two elements, and so on. In embodiments, the rotating aligns each element within each row of the matrix with a unique memory bank 144 in the plurality of memory banks. Recall that each column in the memory array is associated with a unique memory bank within the plurality of memory banks. The rotating can align each element within each row (for a row-major matrix) or each element within a column (for a column-major matrix) to be aligned with a unique memory bank. In embodiments, the saving is accomplished within a single cycle of the memory array.

The saving results in a diagonal format 132 of the matrix within the memory array. Once rotated to the right, the array can be stored in the memory array such that each element of a row of the matrix can be spread across multiple rows within the matrix, forming a diagonal. The diagonal matrix includes a plurality of rows and columns. For example, a 3×3 row-major matrix can include A0, A1, A2 as the initial row. The saving can shift these three elements across all three rows. Thus, A0 can be saved at position (0,0) in the matrix; A1 can be saved at position (1, 1) in the memory array; and A2 can be saved at position (2,2) in the memory array. Thus, the initial row in the matrix can be stored along the major diagonal of the memory array. Other rows can be similarly stored on minor diagonals within the memory array. Similarly, a column-major matrix can include A0, A1, A2 as the first column. The saving can shift these three elements across all three rows. Thus, A0 can also be saved at position (0,0) in the matrix; A1 can also be saved at position (1, 1) in the memory array; and A2 can also be saved at position (2,2) in the memory array. Thus, the initial row in a row-major matrix can be stored along the major diagonal of the memory array, while other rows can be similarly stored on minor diagonals within the memory array. Likewise, the initial column in a column-major matrix can be stored along the major diagonal of the memory array while other columns can be similarly stored on minor diagonals within the memory array. This format within the memory array can enable a high-performance transpose of any matrix stored in row-major form or column-major form. The saving can be based on one or more control signals. The control signal can include whether the matrix is in row-major or column-major format.

The flow 100 includes reading, from the memory array, the diagonal format 150 of the matrix. Recall that the rotating to the right can ensure that memory-contiguous elements of the matrix were stored via a different memory bank within the memory array. This allowed the writing of the array to occur in a single cycle. Similarly, because each element of each row can still be accessed by a unique memory bank, the memory array can be read quickly. In embodiments, the reading is accomplished within a single cycle of the memory array. The reading includes rotating, to the left 152, each row within the diagonal format of the matrix. The rotating to the left can be similar to the rotating to the right. That is, the rotating to the left can also be based on a row index. The row index can start with zero for the first row of the matrix. Thus, the first row can be rotated left by zero elements (no rotations), the second row can be rotated left by one element, the third row can be rotated left by two elements, and so on. The reading produces a transpose of the matrix 160. Thus, a column-major matrix, which can be the transpose of a row-major matrix, can be created from the diagonal format. Similarly, a row-major matrix, which can be the transpose of a column-major matrix, can be created from the diagonal format.

In order to store and subsequently read the matrix in the diagonal format, the memory array can contain at least as many rows and columns as the matrix. In embodiments, the memory array comprises at least i columns. In other embodiments, the memory array comprises at least j rows. The request can include a second matrix to be transposed. The request can include any number of matrices to be transposed. A second request can be made to the memory array. The second request can include a second array. Any number of requests can be made to the memory array, thus enabling the memory array to sustain continuous matrix transpose operations. In embodiments, the receiving includes a second matrix. The second matrix can be the same size or a different size than the first matrix. The memory array can be designed to be large enough to hold more than one matrix in the diagonal format at a time. In embodiments, the memory array stores two or more matrices 170. Additional matrices can be stored vertically (e.g., “below” the first matrix in the memory array). That is, additional matrices can comprise higher row indexes than the first matrix. Recall that a row within a matrix can be accessed by a row address which can be a row index. When more than one matrix is stored in the memory array in a vertical format, a base address can be added to the row index to select other matrices that can be stored within the memory array. That is, the base address can be added to the row index to “skip ahead” in the memory array to the desired row of the correct matrix. The base address can index between matrices stored in the memory array.

Additional matrices can also be stored horizontally (e.g., “next to” the first matrix in the memory array). That is, additional matrices can comprise higher column indexes than the first matrix. The base address can be added to a column address, which can be a column index, to select other matrices that can be stored within the memory array. That is, the base address can be added to the column index to “skip across” in the memory array to the desired row of the correct matrix. In embodiments, the saving and the reading include a base address. Some embodiments include indexing, by the base address, between the matrix and the second matrix 172 stored in the memory array.

Since it takes a cycle to write a matrix to the array and a second cycle to read data out of the array, a single memory array as disclosed in above embodiments can perform a matrix transpose function every other cycle. As described previously, the single memory array can be included in a processor, multi-core processor, SoC, AI accelerator, and so on. Any number of memory arrays can be included. The combination of two or more memory arrays can comprise a streaming matrix transposer. Any number of memory arrays can be included. The streaming matrix transposer can be included in the processor, multi-core processor, SoC, AI accelerator, etc.

In embodiments, the accessing includes a second memory array. The second memory array can be identical in size or a different size than the memory array. A first matrix associated with the request can be transposed by a first memory array, a second memory array, or another memory array. In a usage example, a first request is received to transpose matrix A. On the next cycle, the request is sent to a memory array, which can be a first memory array. The first request includes rotating right and writing the matrix to the first memory array in the diagonal format. In the next cycle, a second request can be received to transpose matrix B. Since the first memory array is busy processing the transpose of matrix A, the request can be sent to a second memory array. On that cycle, matrix B can be rotated to the right and written to the second memory array in the diagonal format while the diagonal format of matrix A is read from the first memory array (which can include left-shifting to produce the transpose of matrix A). In the next cycle, the first memory array can accept a third request to transpose matrix C while the second memory array completes the transpose of matrix B. In embodiments, the request includes alternating between the memory array and the second memory array 180. The pipelined process such as described above can continue with any number of matrix transpose requests by alternating memory arrays such that a matrix transpose is created every cycle. In embodiments, the memory array and the second memory array comprise a streaming matrix transposer.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

FIG. 2 is a flow diagram for assembling submatrices. Machine learning models such as convolutional neural networks, large language models, transformers, and so on can operate with extremely large matrices and/or tensors which can comprise many dimensions of large matrices. Performing matrix operations, such as a transpose operation, can result in significant performance limitations for traditional processing elements such as a processor core, multi-core processor, etc. Disclosed embodiments provide techniques for accelerating a matrix transpose, a key matrix operation in support of AI performance. Matrices have associative properties such that a large matrix transpose operation can be divided into multiple, smaller transpose operations which, when properly combined, produce the same result. The smaller matrices can be submatrices of the larger matrix. Disclosed embodiments can operate on submatrices, enabling significant parallelism, and thus accelerating extremely complex machine learning operations. A memory array is accessed. The memory array includes a plurality of memory banks. Each column in the memory array is associated with a unique memory bank within the plurality of memory banks. A request is received to transpose a matrix which comprises i rows and j columns. The matrix is saved in the memory array, which includes rotating, to the right, each row within the i rows. The rotating is based on a row index. The saving results in a diagonal format of the matrix within the memory array. The diagonal format of the matrix is read from the memory array, which includes rotating, to the left, each row with the diagonal format of the matrix. The reading produces a transpose of the matrix.

The flow 200 includes receiving a request 210 to transpose a matrix, wherein the matrix comprises i rows and j columns. As described above and throughout, a transpose of a matrix can swap the rows and columns of a matrix. That is, a transpose function can convert a row-major view of a matrix to a column-major view of the matrix, and vice versa. The transpose request can be sent by a processing element such as a processor core, a multi-processor chip, an application specific integrated circuit (ASIC), a system-on-chip (SOC), an AI accelerator, a network of elements, and so on. The memory array can be integrated on any processing element such as those listed above or a standalone chip. The request can be generated from the same chip as the memory array or a different chip. Further, the request can be sent over a communications protocol such as the peripheral component interconnect express (PCIe). The request can include handshaking between the memory array and other elements. The request can include the matrix. Alternatively, the matrix can be located in a register file, a memory address, a cache, and so on. In this case, the request can include an address to access the matrix. The matrix can be any size. The matrix comprises i rows and j columns.

The flow 200 includes dividing into submatrices 220. Embodiments include dividing the matrix into at least two submatrices. The submatrices can comprise blocks of a matrix. The block, or submatrix, can comprise any number of rows and columns which can divide the matrix. For example, a 4×4 matrix such as:

$$[ \begin{matrix}0 & 1 & 2 & 3 \\ 4 & 5 & 6 & 7 \\ 8 & 9 & 10 & 11 \\ 12 & 13 & 14 & 15\end{matrix} ]$$

can be represented as four 2×2 blocks:

$$[ \begin{matrix}A & B \\ C & D\end{matrix} ]$$

where

$$A = [ \begin{matrix}0 & 1 \\ 4 & 5\end{matrix} ] , B = [ \begin{matrix}2 & 3 \\ 6 & 7\end{matrix} ] , C = [ \begin{matrix}8 & 9 \\ 12 & 13\end{matrix} ] , and D = [ \begin{matrix}10 & 11 \\ 14 & 15\end{matrix} ] .$$

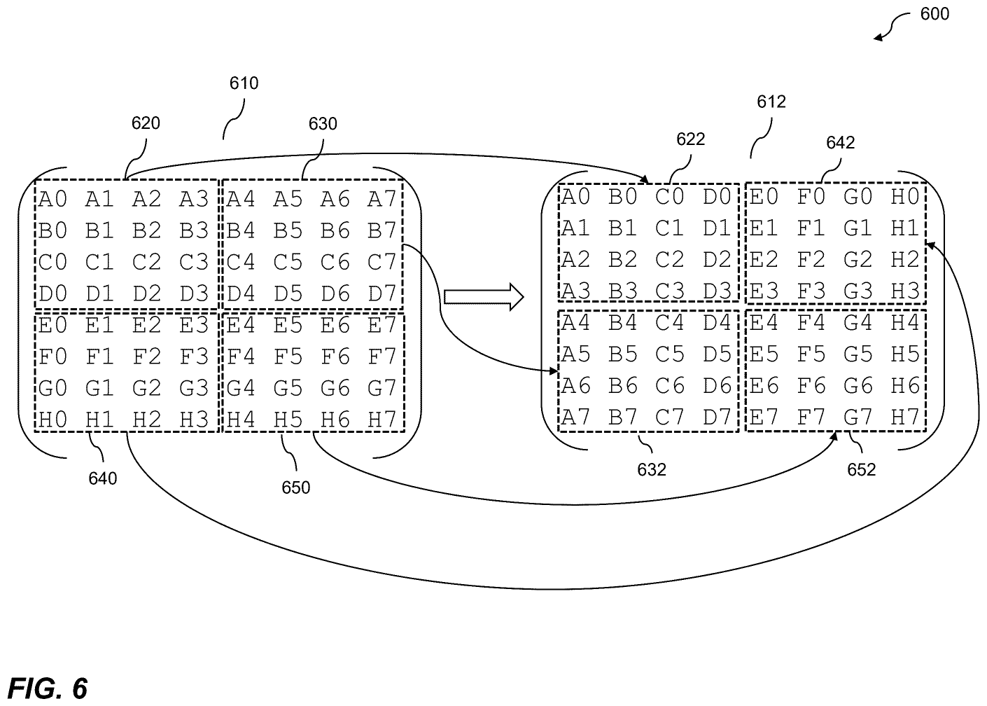

Matrix operations on the four 2×2 blocks can be performed by treating the blocks as matrix entries. Once the matrix operations are complete, the 2×2 blocks can then be recombined to form a larger resulting matrix (explained further in FIG. 6). While this is a simple example, similar functionality can be performed on much larger matrices with row and column counts into the hundreds, thousands, or more. Breaking up a large matrix into more manageably sized matrices can enable computational efficiency when performing operations such as a matrix transpose on the larger matrix.

As described above, a memory array can store a matrix in a diagonal format. The diagonal format can include a right rotation of one or more rows of the matrix. The diagonal format of the matrix can be read from the memory array, which can include one or more rotations to the left. The reading can produce a transpose of the matrix. The memory array can be designed to transpose a matrix of any size. However, the request may include a matrix that is larger than the design of the memory array. In that case, the matrix can be divided into at least two submatrices. The request can then include one or more of the submatrices. A separate request can be made to transpose each submatrix. In embodiments, the saving and the reading includes a first submatrix within the at least two submatrices.

The flow 200 includes producing a transpose of the first submatrix 230. The memory array can process the request to produce a transpose of the submatrix according to embodiments above. Thus, in embodiments, the saving and the reading produces a transpose of the first submatrix. A second request can include a second submatrix within the two or more submatrices. Thus, in embodiments, the saving and the reading includes a second submatrix within the one or more submatrices. As described above, the second request can be made to a second memory array, thus producing a streaming matrix transposer capable of calculating a transpose of each submatrix every cycle once the first memory array is loaded. Additional memory arrays can be included to further parallelize matrix transpose requests. For example, a larger matrix could be divided into eight requests. Eight separate memory arrays can be deployed to handle all eight requests simultaneously, thus producing the transpose of each submatrix within two cycles. While additional clock cycles may be required to assemble the final matrix, this can represent a significant acceleration of a transpose of a large matrix.

The flow 200 includes producing a transpose of the second submatrix 240. In embodiments, the saving and the reading produce a transpose of the second submatrix. In similar fashion to the processing of the first submatrix, the second submatrix can be rotated to the right, saved in a diagonal format such as described above, read from the matrix, and rotated left to form the transpose of the second matrix. The second matrix transpose can be performed by the first memory array or another memory array. The second matrix can be stored in the first memory array along with the first matrix. In this case, the second matrix can be accessed by a base address. The base address can be 0 for the first matrix. The base address of the second matrix can be equivalent to the number (N) of rows contained in the diagonal format of the first matrix. Thus, row 0 of the second matrix can be accessed by an address of N, row 1 of the second matrix can be accessed by N+1, and so on.

The flow 200 includes assembling submatrices 250. Embodiments include assembling the transpose of the first submatrix and the transpose of the second submatrix, wherein the assembling comprises a transpose of the matrix. The transpose of each submatrix can be placed within the larger resulting transposed matrix. Each submatrix can be placed immediately after it is transposed, after all the submatrices are transposed, etc. The placing can complete the transposing of the larger matrix. Thus, an efficient large matrix transpose can be accomplished with one or more memory array.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

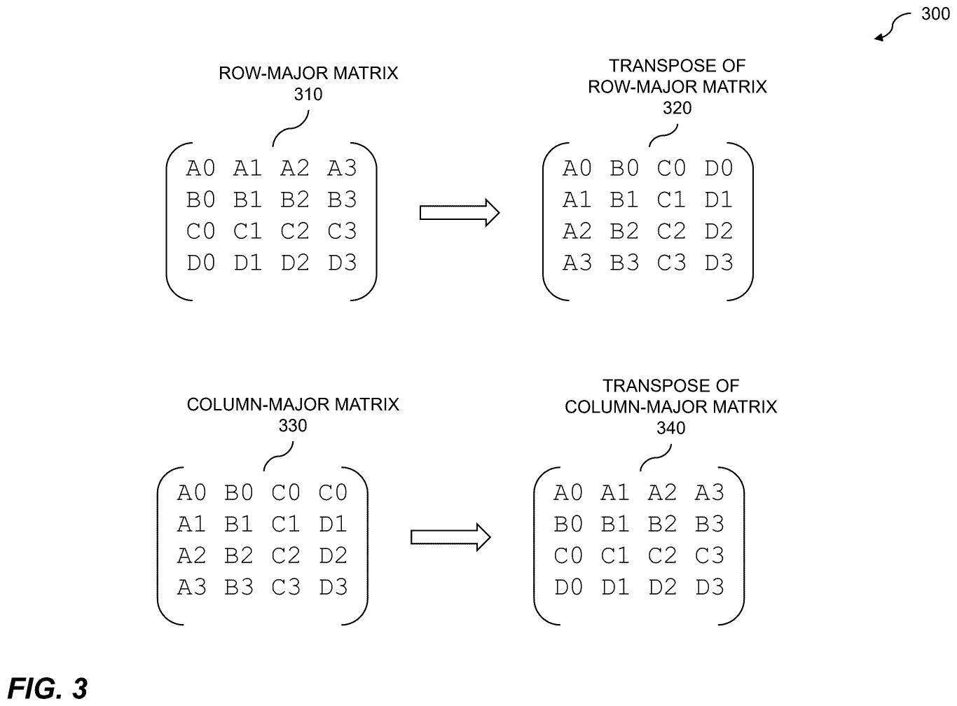

FIG. 3 is an example of transposing a matrix. A transpose of a matrix can be a fundamental matrix algebraic function required in order to multiply two matrices. In some situations, a transformation, such as a matrix transpose, is required to convert a matrix into a form by which it can be multiplied by another matrix. However, multiplying two matrices is only possible when the number of rows in a first matrix is the same as the number of columns in a second matrix. In some situations, such as processing matrices within a machine learning model, a transformation such as a matrix transpose is required to convert a matrix into a form by which it can be multiplied by another matrix. In a simple usage example, a need may arise to multiply a 4×3 matrix by a 4×3 matrix. Mathematically, this operation would be undefined since the number of rows in the first matrix (4) is not equal to the number of columns in the second matrix (3). However, transposing the second matrix results in a 3×4 matrix. Now, the number of rows of the first matrix (4) is equal to the number of columns of the second matrix (4), and the multiplication can be performed. The transformation of the data can be taken into account later in subsequent calculations.

The example 300 shows a row-major matrix 310. The row-major matrix can comprise a row-major order. The row-major matrix can indicate that values within the rows of the matrix are stored contiguously in memory. That is, in 310, A0, A1, A2, and A3 are contiguous in memory. Similarly, B0, B1, B2, and B3 can be stored in contiguous memory locations. The memory can comprise any type of memory such as a buffer, SRAM, DRAM, etc. The example 300 shows a transpose of the row-major matrix 320. A transpose function can swap the row and column values of a matrix. The transpose of the row-major matrix now shows that the columns within 320 are stored contiguously in memory. Note that nothing has changed within the memory storage, only the representation of the elements within the matrix itself. Thus, A0, A1, A2, and A3 are still stored contiguously in memory, but they now align with a column in the array instead of a row. Thus, the transpose of the row-major matrix can be called a column-major matrix.

The example 300 shows a column-major matrix 330. The column-major matrix can comprise a column-major order. The column-major matrix can indicate that values within the columns of the matrix are stored contiguously in memory. That is, in 330, A0, A1, A2, and A3 are contiguous in memory. Similarly, B0, B1, B2, and B3 can be stored in contiguous memory locations. The example 300 shows a transpose of the column-major matrix 340. The transpose of the column-major matrix now shows that the rows within 340 are stored contiguously in memory. As in the first example above, nothing has changed within the memory storage, only the representation of the elements within the matrix itself. Thus, A0, A1, A2, and A3 are still stored contiguously in memory, but they now align with a row in the array instead of a column. Thus, the transpose of the column-major matrix can be called a row-major matrix. In disclosed embodiments, the memory array can transpose row-major matrices or column-major matrices. The disclosed diagonal format can be used in either case to accomplish the matrix transpose in two cycles.

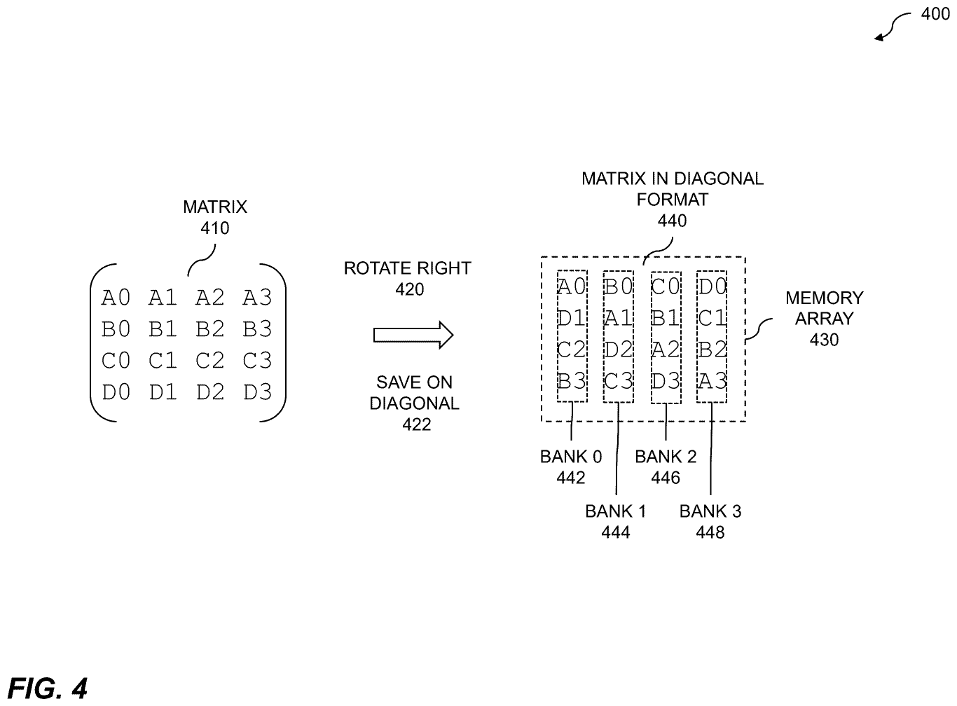

FIG. 4 is an example of generating a column address. A column address can be used to store a matrix in a diagonal format within a memory array such as described above. The example 400 includes a matrix 410. The matrix can be in row-major order as shown. The matrix can also be in column-major order. The memory array can transpose a row-major matrix into a column-major matrix and/or a column-major matrix into a row-major matrix. The row-major matrix shown in the example 400 includes four rows and four columns, thus it can be considered an “n×n” (or square) matrix. In general, the matrix can include any number of i rows and j columns.

The example 400 includes rotating to the right 420. Embodiments include saving, in the memory array, the matrix, wherein the saving includes rotating, to the right, each row within the i rows, wherein the rotating is based on a row index. Each of the rows of the matrix can be rotated to the right based on a row index, which can be a row address. The row index can start at 0. Thus, the first row of matrix 410 can be associated with a row index of 0, the second row can be associated with row index of 1, the third row with a row index of 2, and the fourth row with a row index of 3. Rotations based on the row index can result in no change to the first row (since it would be rotated by zero positions). The second row can be rotated by one position, resulting in B3, B0, B1, B2. The second row can be rotated by two positions, resulting in C2, C3, C0, C1. Likewise, the fourth row can be rotated by 3 positions resulting in a D1, D2, D3, D0. Notice that, after the rotations to the right, each element within each row has been dispersed differently across each of the rows, based on the row index.

The example 400 includes saving on a diagonal 422. In embodiments, the saving results in a diagonal format of the matrix within the memory array. To generate the diagonal format, the columns of the rotated matrix can be shifted up or down such that, when read from the array and shifted to the left by the row index, the transpose of the matrix can result. The saving can be based on a column address. A memory array 430 is shown. The matrix in diagonal format 440 can be saved within the memory array. The shifting can cause each element within each original row to appear on a different row and column address within the diagonal format matrix. For example, A0, A1, A2, and A3 were previously saved in row 0 with respective addresses (0,0), (0,1), (0,2), and (0,3). In the diagonal format, A0 is still located at (0,0), but A1 is located at (1,1), A2 is located at (2,2) and A3 is located at (3,3). That is, the rotating and the shifting have caused the elements of A to be aligned along the major diagonal of the matrix. Similarly, the elements of B, C, and D have been aligned along other (minor) diagonals of the matrix. While the row address is based on the rotating right, a column address can be determined for each element in the original matrix to create the diagonal matrix after the rotations are completed. The column addresses can be generated and/or the shifting can occur before the rotations as well. The column address can be used to save the diagonal matrix within the memory array. For example, for a 4×4 matrix as shown, the column address of A0 remains 0, the column address of A1 is 1, the column address of A2 is 2, and the column address of A3 is 3. The column addresses for all elements of all rows of the matrix 440 can be chosen such that when the array is read from the memory array, a left shift can result in a transpose of the matrix. Matrices of other sizes can require different column addresses. The column addresses can be different when transposing a row-major matrix and a column-major matrix.

Recall that the memory array comprises a plurality of memory banks and that each column in the memory array is associated with a unique memory bank. The memory array shown comprises four memory banks: bank 0 442 which is associated with the first column of the memory array, bank 1 444 which is associated with the second column of the memory array, bank 2 446 which is associated with the third column of the memory array, and bank 3 448 which is associated with the fourth column of the memory array. Each bank can be read from or written to independently. Thus, the first column of the diagonal format (A0, D1, C2, B3) can be written to the memory array concurrently with the second column (B0, A1, D2, and C3), and so on. Similarly, all columns can be written simultaneously. In embodiments, the saving is accomplished within a single cycle of the memory array. The rotating to the right and the saving can be accomplished in the same cycle.

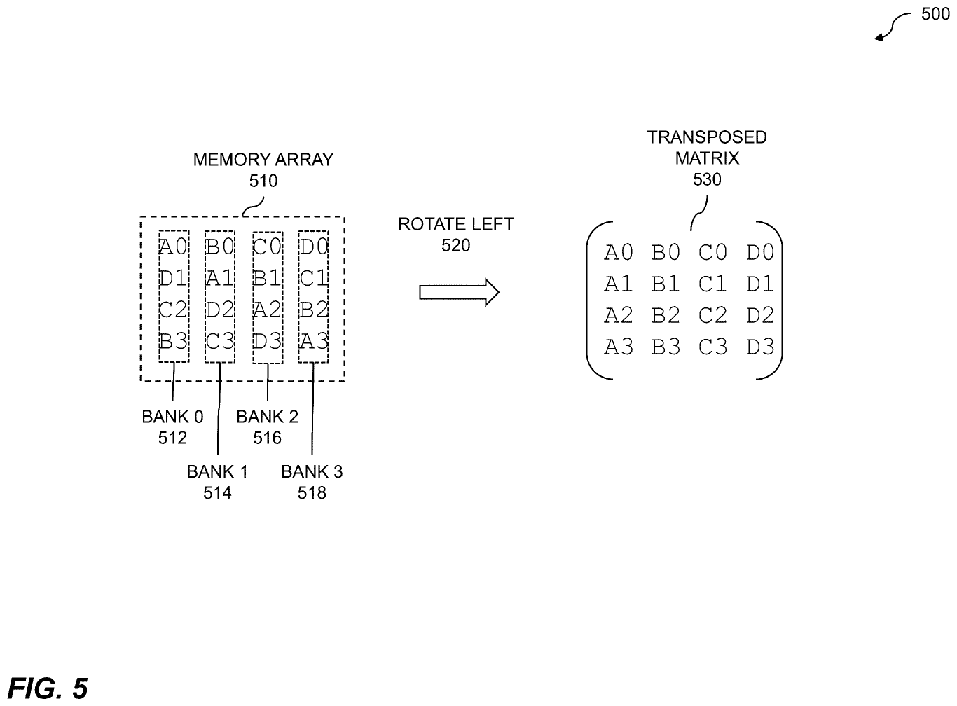

FIG. 5 is an illustration of reading a transposed matrix from a memory array. The illustration 500 continues the example previously described in FIG. 4. Recall that in FIG. 4, a diagonally formatted matrix was saved in a memory array from an initial row-major matrix. The diagonally formatted matrix is again shown 510. As before, the memory array in illustration 500 comprises four memory banks: bank 0 512 which is associated with the first column of the memory array, bank 1 which 514 is associated with the second column of the memory array, bank 2 516 which is associated with the third column of the memory array, and bank 3 518 which is associated with the fourth column of the memory array. The memory array can comprise any number of memory banks. Each bank can be read from or written to independently. Thus, the first column of the diagonal format (A0, D1, C2, B3) can be read from the memory array concurrently with the second column (B0, A1, D2, and C3), and so on.

The illustration 500 includes rotating left 520. Embodiments include reading, from the memory array, the diagonal format of the matrix, wherein the reading includes rotating, to the left, each row within the diagonal format of the matrix, and wherein the reading produces a transpose of the matrix. Each memory bank can be accessed concurrently to read all columns out of the memory array. Once read, each of the rows of the matrix can be rotated to the left based on a row index. This operation can be similar to the right rotations associated with saving the matrix in a diagonal format to the memory array. The row index can start at 0. The rotating to the left can be based on the row index. Thus, the first row, which can be associated with a row index of zero, can be rotated zero times to the left, producing A0, B0, C0, D0. The second row, which can be associated with a row index of one, can be rotated one time to the left, producing A1, B1, C1, D1. The third row, which can be associated with a row index of two, can be rotated two times to the left, producing A2, B2, C2, D2. The fourth row, which can be associated with a row index of three, can be rotated three times to the left, producing A3, B3, C3, D3. The resulting matrix is shown in illustration 500 which is the transposed matrix 530. In embodiments, the reading is accomplished within a single cycle of the memory array. The reading and the rotating to the left can occur on the same cycle. Recall that the saving and the rotating to the right can also occur in a single cycle previous to the reading and the rotating to the left. Thus, the memory array can comprise a 2-cycle memory transpose function of any size matrix.

FIG. 6 is an example of dividing a large matrix transpose function. Machine learning models can require matrix operations to perform training and inferencing. A machine learning model, such as a neural network, can comprise a large number of layers. The layers can include an input layer, hidden layers, an output layer, and so on. A layer can include any number of neurons which can calculate a value. The neurons within any non-input layer of the network can be coupled to any number of neurons from a previous layer. The output from each neuron can be sent to one or more neurons in a subsequent level within the network. The value calculated by each neuron within each layer can be based on a weight value multiplied by an activation from a previous node within a previous layer. Each activation value can be associated with a unique weight. Thus, the output of any layer within the neural network can be represented by a matrix multiplication of an activation matrix multiplied by a weight matrix. Today's generative AI models can comprise many layers with thousands or millions of interconnected neurons, which can be nodes. As a result, these models can require matrix algebra functions, notably matrix multiply functions, with matrices comprising row and column counts in the thousands, hundreds of thousands, or more. As described previously, in the course of managing and multiplying large matrices, the need for other functions, such as a matrix transpose, can arise. Thus, there can be a need to transpose many of these larger matrices. For example, to multiply a weight matrix with an input matrix, either matrix may need to be reformatted to match the expected input structure of the network.

The example 600 shows a starting matrix 610. In the example 600, the starting matrix comprises eight rows and eight columns. In practice, as described above, the starting matrix can comprise thousands (or more) of rows and columns. The size of larger matrices can make a direct transpose of the matrix difficult to implement directly in hardware. Taking advantage of inherent parallelism, disclosed embodiments can divide larger matrices into small matrices, thus allowing many smaller matrix operations, such as a matrix transpose, to be performed on submatrices, reducing complexity and increasing performance.

The matrix 610 can be divided into four submatrices, or blocks. Embodiments include dividing the matrix into at least two submatrices. In practice, the block or submatrices which can divide the original matrix can comprise any number of rows and columns. In the example 600, submatrix 620 comprises a 4×4 matrix, as does submatrix 630, submatrix 640, and submatrix 650. Matrix operations on the four 4×4 blocks can be performed by treating the blocks as matrix entries. In the example 600, each 4×4 submatrix is transposed. The result is then combined into a transposed 8×8 matrix 612.

To generate the transposed matrix, submatrix 620 is transposed to form transposed submatrix 622, submatrix 630 is transposed to form transposed submatrix 632, submatrix 640 is transposed to form transposed matrix 642, and submatrix 650 is transposed to form transposed submatrix 652. Each of the transposes listed above can be accomplished by the memory array or a combination of memory arrays as disclosed above. For example, a single 4×4 memory array can accomplish the matrix transpose of each 4×4 submatrix shown in example 600 in two cycles. Thus, a single 4×4 memory array can accomplish the four different transposes in eight cycles. As defined above, this can include rotating each submatrix to the right based on a row index, saving each submatrix to the memory array in a diagonal format, reading the matrix from the memory array, and rotating elements to the left based on the row index. In embodiments, the saving and the reading include a first submatrix within the at least two submatrices. In further embodiments, the saving and the reading produces a transpose of the first submatrix. In other embodiments, the saving and the reading includes a second submatrix within the one or more submatrices. In some embodiments, the saving and the reading produce a transpose of the second submatrix.

Once the submatrix operations are complete, the four 4×4 submatrices in example 600 can be recombined to determine the result of the larger matrix operation. Note that the recombining is also based on a matrix transpose function. That is, the matrix 610 can be thought of as a 2×2 matrix of the submatrices. Submatrix 620 is originally located at (0,0), submatrix 630 is originally located at (0,1), submatrix 640 is originally located at (1,0) and submatrix 650 is originally located at (1,1). The submatrices are transposed such that submatrix 622, which is a transpose of submatrix 620, is located in the transposed matrix at (0,0), submatrix 642, which is a transpose of submatrix 640, is located in the transposed matrix at (0,1), submatrix 632, which is a transpose of submatrix 630, is located in the transposed matrix at (1,0), and submatrix 652, which is a transpose of submatrix 650, is located in the transposed matrix at (1,1). Thus, submatrices 622, 632, 642, and 652 not only comprise transposed values, but their locations have themselves been transposed to form the transposed matrix 612. Embodiments include assembling the transpose of the first submatrix and the transpose of the second submatrix, wherein the assembling comprises a transpose of the matrix.

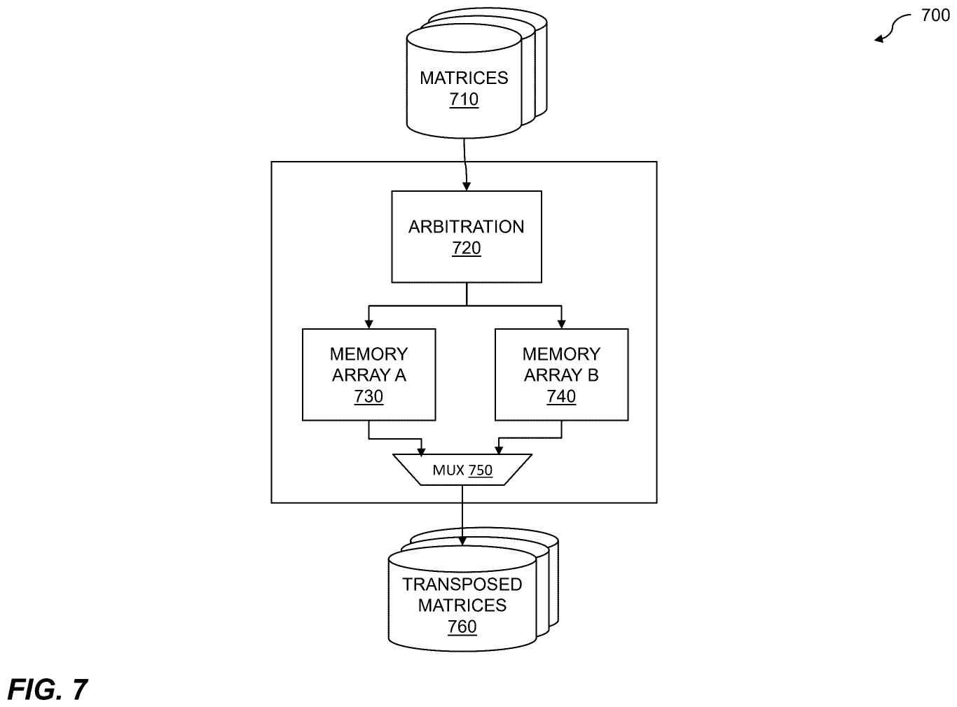

FIG. 7 is a block diagram of a streaming matrix transposer. As described above and throughout, a memory array can be used to perform a matrix transpose function on a matrix. However, as previously discussed, situations can occur, especially when training and running inferences on advanced machine learning models where one or more matrices must be transposed to accomplish a multiplication or another matrix function. These transpose functions can be required to be performed on extremely large matrices which can stretch the limits of hardware. Large matrix transpose requests can be accelerated by dividing the original matrix into two or more submatrices. A transpose can then be performed both on the data within the submatrices and on the positions of the submatrices themselves. In addition, a need for rapid transposing of multiple matrixes may also arise in some models. Whether generated by a division of a large matrix transpose or a need to perform many rapid smaller independent matrix transposes, coupling two or more memory arrays can form a high-performance streaming matrix transposer.

The block diagram 700 includes one or more matrices 710. The matrices can be included in one or more transpose requests. The matrices can be of any size. Embodiments include receiving a request to transpose a matrix, wherein the matrix comprises i rows and j columns. In embodiments, the receiving includes a second matrix. The matrices can comprise row-major form or column-major form. The block diagram includes arbitration 720. The arbitration can manage requests to transform the one or more matrices between one or more memory arrays. The arbitration can implement round-robin scheduling or another scheduling technique to distribute the requests and the matrices to the memory arrays. The arbitration can be controlled by a microcontroller, a state machine, one or more flip-flops, and so on.

The block diagram includes memory array A 730. Embodiments include accessing a memory array, wherein the memory array includes a plurality of memory banks, and wherein each column in the memory array is associated with a unique memory bank within the plurality of memory banks. The memory array can be sized so that it can save the matrices. In embodiments, the memory array comprises at least i columns. In embodiments, the memory array comprises at least j rows. Any number of memory arrays can be included. In block diagram 700, a second memory array, memory array B 740, is coupled to arbitration. In embodiments, the accessing includes a second memory array. The second memory array can be sized the same or differently than the first memory array, but can be sized at least as large as the matrices which are to be transposed. The memory arrays can perform a matrix transpose in accordance with disclosed embodiments. Each memory array is capable of producing a transpose of a matrix within two clock cycles.

The block diagram includes a multiplexor (mux) 750. The multiplexor can select between the results from memory array A and memory array B. Since each memory array is capable of delivering a matrix transpose every other cycle, a combination of two memory arrays can produce a matrix transpose function every cycle by selecting between the two memory arrays. The mux can be controlled by the arbitration, a timer, control logic, a round robin scheduler, and so on to ensure that correct results, the transposed matrices 760, are generated from the output of the mux. In a usage example, a first request is received to transpose a first matrix in a first cycle. On the next cycle (the second cycle), the request is sent, via arbitration, to a first memory array such as memory array A. The first matrix is rotated to the right and saved within the first memory array in a diagonal format. Also on the second cycle, a second request is received to transpose a second matrix. In the next cycle (the third cycle), memory array A is read, and the resulting matrix is rotated to the left to produce the transpose of the first matrix. The mux selects the result from memory array A. On the same cycle, the second request is sent, by the arbitration, to a second memory array, which can be memory array B. The array is rotated to the right and saved in memory array A in a diagonal format. Meanwhile a third request can be received to transpose a third matrix. On the next cycle (cycle 4), memory array B is read, and the results are shifted to the left to produce a transpose of the second matrix. The transpose of the second matrix is selected by the mux. Meanwhile, since memory array A is available, it can begin the process of transposing the third matrix. Execution can continue in alternating fashion between the two memory arrays. The net result is that the streaming matrix transposer can deliver a matrix transpose every cycle once initially loaded (e.g., the streaming matrix transposer can be pipelined). In embodiments, the receiving includes a second matrix. In embodiments, the request includes alternating between the memory array and the second memory array. In embodiments, the memory array and the second memory array comprise a streaming matrix transposer.

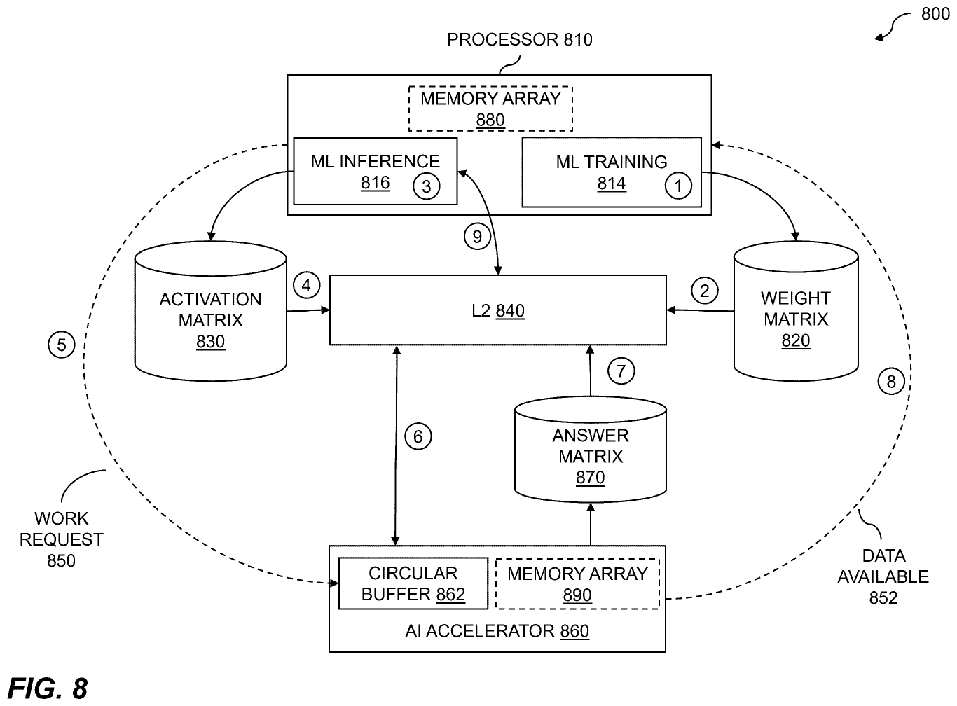

FIG. 8 is a block diagram of an A1 accelerator. The A1 accelerator can comprise a weight-stationary matrix multiply accelerator. As shown in block diagram 800, artificial intelligence program execution can be accelerated through the use of a weight-stationary matrix multiply accelerator. The example 800 shows a processor 810. The processor can comprise a processor core, a multi-processor chip, an SoC, an ASIC, a system of one or more of the aforementioned components, and so on. The processor can run a machine learning model. As shown in step 1, the machine learning model, which can be a neural network, a convolutional neural network, or any other type of machine learning model, can be trained 814. The training of the model can produce a matrix of weights 820 so that the model can generate accurate inferences. The weights can be stored in a memory hierarchy which can include an L2 cache 840. The L2 cache can be coupled to the processor and the AI accelerator 860. As shown in step 2, the weight matrix can be stored in the L2 cache so that it can be accessed in the future when an inference is executed 816 by the machine learning model running on the processor. This occurs in step 3 in example 800. While executing, the machine learning model can produce an activation matrix 830 which can be multiplied by the weight matrix as a step in the inferencing process. The activation matrix can be saved to the L2 cache by the processor in step 4. Once the activation matrix is in the L2 cache, the processor can send a work request 850 to the accelerator as shown in step 5 of example 800. The work request can be based on a semaphore. The work request can be received, as shown in step 5, by a circular buffer 862 within the accelerator core. The work request can specify an address for the activation matrix and the weight matrix which were both stored, by the processor core, in the L2 cache. The work request can also specify a memory location for an answer matrix that can be generated by the accelerator. The addresses can be physical addresses. A cache miss can occur, which can cause the accelerator to pause until the activation matrix and weight matrix are loaded.

Once the matrices are loaded (step 6), the accelerator core can perform the matrix multiplication of the activation matrix and the weight matrix. The result can be an answer matrix 870 which can be written to the L2 cache by the accelerator, as shown in step 7. The answer matrix can be written to the location as specified in the work request. The accelerator can then notify the processor core that the answer matrix is available 852 in response to the work request that was received, as shown in step 8. The notification can be based on a semaphore. Once the processor has received notification, it can load the answer matrix from the L2 cache, as shown in step 9. As the machine learning model continues to execute, another activation matrix can be sent to the L2 cache, and the process can restart. When restarting, the weight matrix can be saved within the accelerator core so that only the new activation matrix must be loaded to perform another matrix multiplication. In this way, the weights can be “stationary” in the accelerator.

One or more memory arrays can be included in the processor 810, in the AI accelerator core 860, or in other locations in the block diagram 800. In the course of performing training and inferencing, conditions can arise which may require one or more matrices, including one or more activation matrices, the weight matrix, the answer matrix, or another matrix, to be transposed. At any point in time, a matrix can be sent to any memory array in the processor, the AI accelerator, etc. to perform a high performance, low latency matrix transpose operation. Memory arrays 880 and 890 can each include one or more memory arrays to improve performance when many matrix transposes are required. Either or both of the memory arrays shown in block diagram 800 can comprise the streaming matrix transposer of FIG. 7.

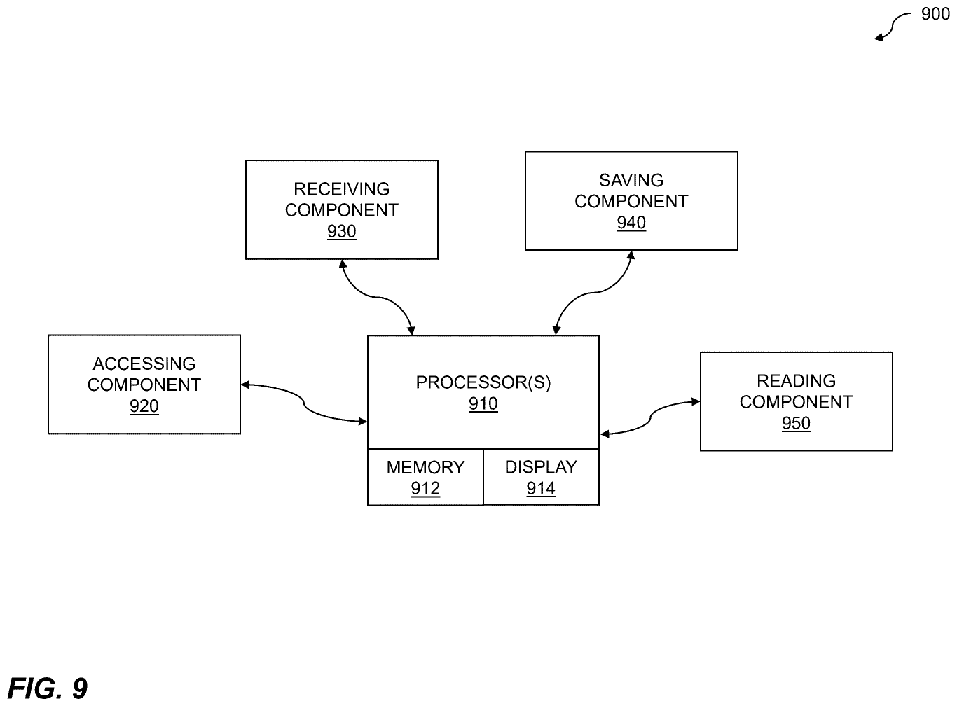

FIG. 9 is a system diagram for a streaming matrix transposer with diagonal storage. High performance, low latency matrix transpose functions can be enabled by a streaming matrix transposer. The matrix transposer can be based on one or more memory arrays which can perform a matrix transpose function. The system 900 can include instructions and/or functions for design and implementation of integrated circuits that support a streaming matrix transposer with diagonal storage. The system 900 can include instructions and/or functions for generation and/or manipulation of design data such as hardware description language (HDL) constructs for specifying the structure and operation of an integrated circuit. The system 900 can further perform operations to generate and manipulate Register Level Transfer (RTL) abstractions. These abstractions can include parameterized inputs that enable specifying elements of a design such as a number of elements, sizes of various bit fields, and so on. The parameterized inputs can be input to a logic synthesis tool which in turn creates the semiconductor logic that includes the gate-level abstraction of the design that is used for fabrication of integrated circuit (IC) devices.

The system can include one or more of processors, memories, cache memories, displays, and so on. The system 900 can include one or more processors 910. The processors can include stand-alone processors within integrated circuits or chips, processor cores in FPGAs or ASICs, and so on. The one or more processors 910 are coupled to a memory 912, which stores operations. The memory can include one or more of local memory, cache memory, system memory, etc. The system 900 can further include a display 914 coupled to the one or more processors 910. The display 914 can be used for displaying data, instructions, matrices, diagonal formats, transposes of matrices, and the like. The operations can include instructions and functions for implementation of integrated circuits, including processor cores. In embodiments, the processor cores can include RISC-V™ processor cores.

The system 900 can include an accessing component 920. The accessing component 920 can include functions and instructions for accessing a memory array, wherein the memory array includes a plurality of memory banks, and wherein each column in the memory array is associated with a unique memory bank within the plurality of memory banks. The memory array can include any number of rows and columns and can be included in a processor core, a multi-core processor chip, an application specific integrated circuit (ASIC), an AI accelerator, a system-on-chip (SoC) and so on. The memory array can be coupled to other elements such as a memory hierarchy which can include an L1, L2, and L3 cache, I/O components, and so on. The memory banks can comprise elements such as buffers, DRAM, SDRAM, DDR SDRAM, HBM memory, and so on. The memory banks can include a single read port. Thus, a memory port can access a column of data, within the memory array, on a single read port. Other configurations of the memory banks with multiple read ports are possible.

The system 900 can include a receiving component 930. The receiving component 930 can include functions and instructions for receiving a request to transpose a matrix, wherein the matrix comprises i rows and j columns. A transpose of a matrix can swap the rows and columns of a matrix. That is, a transpose function can convert a row-major view of a matrix to a column-major view of the matrix, and vice versa. The transpose request can be sent by a processing element such as a processor core, a multi-processor chip, an application specific integrated circuit (ASIC), a system-on-chip (SOC), an AI accelerator, a network of such processing elements, and so on. The memory array can be integrated on any processing element such as those listed above, or on a standalone chip. The request can be generated from the same chip as the memory array, or a different chip. Further, the request can be sent over a communications protocol such as the peripheral component interconnect express (PCIe). The request can include handshaking between the memory array and other elements. The request can include the matrix. Alternatively, the matrix can be located in a register file, a memory address, a cache, and so on. In this case, the request can include an address to access the matrix. The matrix can be of any size.

The system 900 can include a saving component 940. The saving component 940 can include functions and instructions for saving, in the memory array, the matrix, wherein the saving includes rotating, to the right, each row within the i rows, wherein the rotating is based on a row index, and wherein the saving results in a diagonal format of the matrix within the memory array. The matrix can be saved by a processor, multi-core processor, SoC, etc. The matrix can comprise any data types such as integer formats, floating point formats, brain floating point formats, Microscaling formats, and so on. Each bank within the memory array can be designed to be at least as wide as the minimal data type to be supported. The rotating can shift values within a row of a matrix. Each row can be rotated by a row index. The row index can start with zero for the first row of the matrix. Thus, the first row can be rotated right by zero elements (no rotations), the second row can be rotated right by one element, the third row can be rotated right by two elements, and so on. The rotating can cause each element within each row to be aligned with a unique memory bank. Once rotated, the array can be stored in the memory array such that each element of a row of the matrix can be spread across multiple rows within the matrix, forming a diagonal. The storing can be based on a column address. The column address can be different for transposing a row-major matrix versus transposing a column-major matrix. This format within the memory array can enable a high-performance transpose of any matrix stored in row-major form or column-major form.

The system 900 can include a reading component 950. The reading component 950 can include functions and instructions for reading, from the memory array, the diagonal format of the matrix, wherein the reading includes rotating, to the left, each row within the diagonal format of the matrix, and wherein the reading produces a transpose of the matrix. Recall that the rotating to the right can ensure that each element of the matrix was stored via a different memory bank within the memory array. This allowed the writing of the array to occur in a single cycle. Similarly, because each element of each row can still be accessed by a unique memory bank, the memory array can also be read in a single cycle. The rotating to the left can be similar to the rotating to the right. That is, the rotating to the left can also be based on a row index. The row index can start with zero for the first row of the matrix. Thus, the first row can be rotated left by zero elements (no rotations), the second row can be rotated left by one element, the third row can be rotated left by two elements, and so on. After storage in the diagonal format, the rotating to the left can align the memory elements along a column. Thus, a column-major view, which can be the transpose of a row-major matrix, can be created from the diagonal format. Similarly, a row-major view, which can be the transpose of a column-major matrix, can be created from the diagonal format. In order to store and subsequently read the matrix in the diagonal format, the memory array can contain at least as many rows and columns as the matrix.

The system 900 can include a computer program product embodied in a non-transitory computer readable medium for data processing, the computer program product comprising code which causes one or more processors to generate semiconductor logic for: accessing a memory array, wherein the memory array includes a plurality of memory banks, and wherein each column in the memory array is associated with a unique memory bank within the plurality of memory banks; receiving a request to transpose a matrix, wherein the matrix comprises i rows and j columns; saving, in the memory array, the matrix, wherein the saving includes rotating, to the right, each row within the i rows, wherein the rotating is based on a row index, and wherein the saving results in a diagonal format of the matrix within the memory array; and reading, from the memory array, the diagonal format of the matrix, wherein the reading includes rotating, to the left, each row within the diagonal format of the matrix, and wherein the reading produces a transpose of the matrix.

The system 900 can include a computer system for data processing comprising: a memory which stores instructions; one or more processors coupled to the memory wherein the one or more processors, when executing the instructions which are stored, are configured to: access a memory array, wherein the memory array includes a plurality of memory banks, and wherein each column in the memory array is associated with a unique memory bank within the plurality of memory banks; receive a request to transpose a matrix, wherein the matrix comprises i rows and j columns; save, in the memory array, the matrix, wherein the saving includes rotating, to the right, each row within the i rows, wherein the rotating is based on a row index, and wherein the saving results in a diagonal format of the matrix within the memory array; and read, from the memory array, the diagonal format of the matrix, wherein the reading includes rotating, to the left, each row within the diagonal format of the matrix, and wherein the reading produces a transpose of the matrix.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for data processing comprising:
accessing a memory array, wherein the memory array includes a plurality of memory banks, and wherein each column in the memory array is associated with a unique memory bank within the plurality of memory banks;
receiving a request to transpose a matrix, wherein the matrix comprises i rows and j columns;
saving, in the memory array, the matrix, wherein the saving includes rotating, to the right, each row within the i rows, wherein the rotating is based on a row index, and wherein the saving results in a diagonal format of the matrix within the memory array; and
reading, from the memory array, the diagonal format of the matrix, wherein the reading includes rotating, to the left, each row within the diagonal format of the matrix, and wherein the reading produces a transpose of the matrix.

2. The method of claim 1 wherein the rotating aligns each element within each row of the matrix with a unique memory bank in the plurality of memory banks.

3. The method of claim 1 wherein the saving is accomplished within a single cycle of the memory array.

4. The method of claim 1 wherein the reading is accomplished within a single cycle of the memory array.

5. The method of claim 1 wherein the memory array stores two or more matrices.

6. The method of claim 5 wherein the receiving includes a second matrix.

7. The method of claim 6 wherein the saving and the reading include a base address.

8. The method of claim 7 further comprising indexing, by the base address, between the matrix and the second matrix stored in the memory array.

9. The method of claim 1 wherein the accessing includes a second memory array.

10. The method of claim 9 wherein the receiving includes a second matrix.

11. The method of claim 10 wherein the request includes alternating between the memory array and the second memory array.

12. The method of claim 11 wherein the memory array and the second memory array comprise a streaming matrix transposer.

13. The method of claim 1 further comprising dividing the matrix into at least two submatrices.

14. The method of claim 13 wherein the saving and the reading include a first submatrix within the at least two submatrices.

15. The method of claim 14 wherein the saving and the reading produce a transpose of the first submatrix.

16. The method of claim 15 wherein the saving and the reading include a second submatrix within the one or more submatrices.

17. The method of claim 16 wherein the saving and the reading produce a transpose of the second submatrix.

18. The method of claim 17 further comprising assembling the transpose of the first submatrix and the transpose of the second submatrix, wherein the assembling comprises a transpose of the matrix.

19. The method of claim 1 wherein the memory array comprises at least i columns.

20. The method of claim 1 wherein the memory array comprises at least j rows.

21. A computer program product embodied in a non-transitory computer readable medium for data processing, the computer program product comprising code which causes one or more processors to generate semiconductor logic for:
accessing a memory array, wherein the memory array includes a plurality of memory banks, and wherein each column in the memory array is associated with a unique memory bank within the plurality of memory banks;
receiving a request to transpose a matrix, wherein the matrix comprises i rows and j columns;
saving, in the memory array, the matrix, wherein the saving includes rotating, to the right, each row within the i rows, wherein the rotating is based on a row index, and wherein the saving results in a diagonal format of the matrix within the memory array; and
reading, from the memory array, the diagonal format of the matrix, wherein the reading includes rotating, to the left, each row within the diagonal format of the matrix, and wherein the reading produces a transpose of the matrix.

22. A computer system for data processing comprising:
a memory which stores instructions;
one or more processors coupled to the memory wherein the one or more processors, when executing the instructions which are stored, are configured to:
access a memory array, wherein the memory array includes a plurality of memory banks, and wherein each column in the memory array is associated with a unique memory bank within the plurality of memory banks;
receive a request to transpose a matrix, wherein the matrix comprises i rows and j columns;
save, in the memory array, the matrix, wherein the saving includes rotating, to the right, each row within the i rows, wherein the rotating is based on a row index, and wherein the saving results in a diagonal format of the matrix within the memory array; and
read, from the memory array, the diagonal format of the matrix, wherein the reading includes rotating, to the left, each row within the diagonal format of the matrix, and wherein the reading produces a transpose of the matrix.
